(19) United States
(12) Patent Application Publication
(10) Pub. No.: US 2025/0203479 A1
(43) Pub. Date: Jun. 19, 2025

(54) ADAPTIVE TERRESTRIAL AND NON-TERRESTRIAL SESSION TRANSFER

(71) Applicant: Dell Products, L.P., Round Rock, TX (US)

(72) Inventor: Ali Esswie, Calgary (CA)

(21) Appl. No.: 18/389,637

(22) Filed: Dec. 19, 2023

(51) Int. Cl. H04W 36/14; H04W 36/00; H04W 84/06

(52) U.S. Cl. CPC H04W 36/144; H04W 36/0033; H04W 36/0085; H04W 84/06

(57) ABSTRACT

A terrestrial radio network node, facilitating an existing communication session with a user equipment, may receive an adaptive session transfer configuration comprising criterion usable to determine to transmit, toward a non-terrestrial radio network node, a context retrieval report corresponding to the existing communication session. The terrestrial node may transmit to the user equipment a link recovery configuration comprising a context identifier indicative of context information corresponding to the existing communication session. The user equipment may determine to transmit to the non-terrestrial node a session transfer request, including the context identifier, according to a timing advance or non-terrestrial resource associated with the non-terrestrial node in the link recovery configuration, that requests transfer of the existing communication session from the terrestrial node to the non-terrestrial node. Based on the context identifier, the non-terrestrial node may retrieve from the terrestrial node session context information usable to facilitate the existing communication session.

### BACKGROUND

The ‘New Radio’ (NR) terminology that is associated with fifth generation mobile wireless communication systems (“5G”) refers to technical aspects used in wireless radio access networks (“RAN”) that comprise several quality of service classes (“QoS”), including ultrareliable and low latency communications (“URLLC”), enhanced mobile broadband (“eMBB”), and massive machine type communication (“mMTC”). The URLLC QOS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary. A RAN node may activate a network energy saving mode to reduce power consumption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise facilitating, by a first radio network node comprising at least one processor, receiving, from network computing equipment, an adaptive session transfer configuration comprising at least one session transfer criterion, determining, by the first radio network node, at least one radio characteristic corresponding to a user equipment, and analyzing, by the first radio network node, the at least one radio characteristic with respect to the at least one session transfer criterion to result in at least one analyzed radio characteristic. Based on the at least one analyzed radio characteristic corresponding to satisfaction of the at least one session transfer criterion, the method may further comprise facilitating, by the first radio network node, transmitting, to the user equipment, context information, corresponding to an existing communication session between the first radio network node and the user equipment, to be usable by the user equipment to facilitate continuance of the existing communication session with a second radio network node.

The first radio network node may be a terrestrial radio network node and the second radio network node may comprise a satellite. In an embodiment, the first radio network node may comprise, or may be communicatively coupled with, a gateway. In an embodiment, the second radio network node may comprise, or may be communicatively coupled with, a gateway.

In an embodiment, the context information may comprise a link recovery configuration comprising a timing advance indication indicative of a timing advance corresponding to the second radio network node.

The at least one radio characteristic may be a number, determined by the first radio network node, of communication link failures between the user equipment and the first radio network node to result in a determined link failure number, and wherein the satisfaction of the at least one session transfer criterion corresponds to the determined link failure number failing to be less than a threshold specified by the at least one session transfer criterion.

The method may further comprise, facilitating, by the first radio network node, receiving, from the user equipment, a radio parameter measurement report comprising an indication of the at least one radio characteristic. The at least one radio characteristic may be a signal strength measured value, determined by the user equipment, corresponding to a downlink signal transmitted by the first radio network node. The determining of the at least one radio characteristic corresponding to user equipment may comprise retrieving the indication of the at least one radio characteristic from the radio parameter measurement report. The satisfaction of the at least one session transfer criterion may correspond to the signal strength measured value failing to be greater than a threshold specified by the at least one session transfer criterion.

In an embodiment, the context information may comprise a link recovery configuration comprising a context information identifier indicative of context information corresponding to the existing communication session. The context information identifier may be usable by the user equipment to transmit, to the second radio network node, a session transfer request message that comprises the context information to be usable by the second radio network node to facilitate delivery of traffic associated with the existing communication session. The link recovery configuration may further comprise at least one non-terrestrial resource indication indicative of at least one non-terrestrial resource usable by the user equipment to transmit to the second radio network node a session transfer request message.

The method may further comprise, facilitating, by the first radio network node, transmitting, to the second radio network node, a session context retrieval report that may comprise session information, corresponding to the existing communication session, that may be usable by the second radio network node to facilitate delivery of traffic associated with the existing communication session with the user equipment. The session information may comprise at least one of: at least one capability indication indicative of at least one capability associated with the user equipment, at least one encryption indication indicative of at least one encryption corresponding to the existing communication session, at least one retransmission indication indicative of at least one traffic packet, corresponding to the existing communication session, scheduled for retransmission by the first radio network node to the user equipment, or at least one traffic payload packet, corresponding to the existing communication session, scheduled for transmission by the first radio network node to the user equipment.

In an embodiment, the first radio network node may be a terrestrial radio network node. The second radio network node may be a terrestrial radio network node. The context information may be transmitted by the second radio network node to a third radio network node, which may comprise a satellite. The context information may be usable by the third radio network node to facilitate conducting the existing communication session with the user equipment. The second radio network node may comprise a satellite gateway communicatively coupled to the third radio network node. The second radio network node may comprise a radio access network node that may be communicatively coupled with a satellite gateway that may be communicatively coupled with the third radio network node.

In an embodiment, the network computing equipment may comprise computing equipment of a core network to which the first radio network node is communicatively coupled.

In another example embodiment, a first radio network node may comprise a processor configured to process executable instructions that, when executed by the processor, facilitate performance of operations, comprising receiving, from a second radio network node, a session information message comprising session information, corresponding to an existing communication session associated with a user equipment, usable by the first radio network node to facilitate the existing communication session with the user equipment. The method may further comprise receiving, from the user equipment, a session transfer request message comprising a session transfer indication indicative to the first radio network node to conduct the existing communication session with the user equipment according to the session information. The method may further comprise conducting, with the user equipment, the existing communication session according to the session information.

In an embodiment, the first radio network node may comprise a satellite. The second radio network node may be a satellite gateway communicatively coupled with a third radio network node that may comprise a terrestrial radio access network node. The session information may be received by the second radio network node from the third radio network node.

The session information may be received by the third radio network node from a fourth radio network node that may comprise a terrestrial radio access network node. The existing communication session may be established between the fourth radio network node and the user equipment before the conducting of the existing communication session between the first radio network node and the user equipment that may result from the session transfer indication.

In yet another example embodiment, a non-transitory machine-readable medium may comprise executable instructions that, when executed by at least one processor of a terrestrial radio access network node, facilitate performance of operations, comprising receiving, from network computing equipment, an adaptive session transfer configuration comprising at least one session transfer criterion. The operations may further comprise determining at least one radio characteristic corresponding to a user equipment with respect to which the terrestrial radio access network node is conducting an existing communication session, and analyzing the at least one radio characteristic with respect to the at least one session transfer criterion to result in at least one analyzed radio characteristic. Based on the at least one analyzed radio characteristic corresponding to satisfaction of the at least one session transfer criterion, the operations may further comprise transmitting, to the user equipment, context information, corresponding to an existing communication session, to be usable by the user equipment to facilitate continuance of the existing communication session with a second radio network node. The operations may further comprise directing, to a non-terrestrial radio network node, a transmission of session information, corresponding to the existing communication session, to be usable by the non-terrestrial radio network node to facilitate conducting of the existing communication session with the user equipment.

The session information may comprise at least one of: at least one capability indication indicative of at least one capability associated with the user equipment, at least one encryption indication indicative of at least one encryption corresponding to the existing communication session, at least one retransmission indication indicative of at least one traffic packet, corresponding to the existing communication session, scheduled for retransmission by the terrestrial radio access network node to the user equipment, or at least one traffic payload packet scheduled for transmission by the terrestrial radio access network node to the user equipment.

Another example method embodiment may comprise receiving, by a user equipment comprising a processor from a terrestrial network node, a link recovery configuration comprising a context information identifier indicative of context information corresponding to a communication session between the user equipment and the terrestrial network node. The method may further comprise determining, by the user equipment, to transfer the communication session from being served by the terrestrial network node to being served by a non-terrestrial network node. The method may further comprise transmitting, by the user equipment to the non-terrestrial network node, the context information identifier to be usable by the non-terrestrial network node to obtain the context information, and conducting, by the user equipment with the non-terrestrial network node, the communication session according to the context information indicated by the context information identifier.

In an embodiment, the link recovery configuration may further comprise a timing advance value, corresponding to the non-terrestrial network node, usable by the user equipment to establish the communication session with the non-terrestrial network node.

In an embodiment, the communication session between the user equipment and the terrestrial network node may be associated with a session quality of service. The link recovery configuration may further comprise a resource indication indicative of at least one non-terrestrial resource, corresponding to the non-terrestrial network node, usable by the user equipment for the conducting of the communication session with the non-terrestrial network node. The at least one non-terrestrial resource may be capable of facilitating the conducting of the communication session by the user equipment with the non-terrestrial network node according to the session quality of service.

The user equipment may avoid flushing context information corresponding to the communication session. The user equipment may resume the communication session with the non-terrestrial network node instead of with the terrestrial network node based on information contained in the link recovery configuration. The user equipment may avoid transmitting a random access preamble to the non-terrestrial network node before the conducting of the communication session with the non-terrestrial network node.

In an embodiment, the context information identifier may be a user equipment identifier corresponding to the user equipment. In an embodiment, the context information identifier may be a session identifier corresponding to the communication session. In an embodiment, the link recovery configuration may further comprise a non-terrestrial network node identifier, indicative of the non-terrestrial network node, usable by the user equipment to facilitate the transmitting of the context information identifier to the non-terrestrial network node.

In an embodiment, the non-terrestrial network node may be a first non-terrestrial network node. The non-terrestrial network node identifier may be a first non-terrestrial network node identifier. The link recovery configuration may further comprise a second non-terrestrial network node identifier corresponding to a second non-terrestrial network node. The method may further comprise determining, by the user equipment, a first signal strength corresponding to the first non-terrestrial network node and a second signal strength corresponding to the second non-terrestrial network node, and determining, by the user equipment, a higher signal strength of the first signal strength or the second signal strength to result in a determined highest signal strength. The context information identifier may be transmitted by the user equipment according to the first non-terrestrial network node or to the second non-terrestrial network node according to the determined highest signal strength (e.g., the user equipment may transmit the context information identifier to the not terrestrial network node corresponding to the determined highest signal strength). The communication session may be conducted with the non-terrestrial network node corresponding to the determined highest signal strength.

In a user equipment example embodiment, a user equipment may comprise a processor configured to process executable instructions that, when executed by the processor, facilitate performance of operations, comprising establishing, with a terrestrial radio network node, a communication session, according to a context. The operations may further comprise receiving, from the terrestrial radio network node, a link recovery configuration comprising context information corresponding to the context and determining to transfer the communication session from the terrestrial radio network node to a non-terrestrial radio network node. The operations may further comprise transmitting, to the non-terrestrial radio network node, a session transfer request message that comprises the context information to be usable by the non-terrestrial radio network node to facilitate the communication session. The operations may comprise conducting, with the non-terrestrial radio network node, the communication session according to the context.

The terrestrial radio network node may be a serving terrestrial radio network node. The non-terrestrial radio network node may be a determined non-terrestrial radio network node of a set of at least one non-terrestrial radio network node with which the user equipment may be capable of communicating. The link recovery configuration may comprise at least one non-terrestrial radio network node identifier associated with the set of at least one non-terrestrial radio network node. The determining to transfer the communication session from the serving terrestrial radio network node to the determined non-terrestrial radio network node may further comprise determining that a communication link between the user equipment and the serving terrestrial radio network node corresponding to the communication session has failed, determining a nonexistence of terrestrial radio network nodes, other than the serving terrestrial radio network node, that is able to facilitate the communication session with respect to the user equipment, determining that the determined non-terrestrial radio network node corresponds to a higher signal strength measurement than at least one signal strength measurement corresponding to the set of the at least one non-terrestrial radio network node.

In an embodiment, the context information may comprise a context identifier indicative of the context. In an embodiment, the conducting, with the non-terrestrial radio network node, the communication session according to the context may comprise avoiding performance of a random access procedures with respect to the non-terrestrial radio network node. In an embodiment, the link recovery configuration may comprise at least one non-terrestrial uplink resource indication indicative of at least one non-terrestrial uplink resource usable by the user equipment to facilitate communication with the non-terrestrial radio network node. The session transfer request message may be transmitted via the at least one non-terrestrial uplink resource.

In an embodiment, the user equipment may be an extended reality appliance. A radio link facilitating the communication session with respect to the extended reality appliance may fail and the communication session may be transferred to the non-terrestrial radio network node such that the extended reality appliance communicates traffic associated with the communication session directly with the non-terrestrial radio network node.

In yet another example embodiment, a non-transitory machine-readable medium may comprise executable instructions that, when executed by a processor of a user equipment, facilitate performance of operations, comprising establishing, with a serving terrestrial radio network node, a communication session, according to a context and receiving, from the serving terrestrial radio network node, a link recovery configuration comprising a context identifier corresponding to the context. The operations may further comprise determining to transfer the communication session from the serving terrestrial radio network node to a determined non-terrestrial radio network node and transmitting, to the determined non-terrestrial radio network node, a session transfer request message that comprises the context identifier to be usable by the determined non-terrestrial radio network node to obtain context information corresponding to the context. The method may further comprise conducting, with the determined non-terrestrial radio network node, the communication session according to the context.

In an embodiment, the link recovery configuration may comprise a timing advance indication corresponding to a timing advance associated with the determined non-terrestrial radio network node.

In an embodiment, context information corresponding to the context may be stored in a memory of the user equipment. The session transfer request message may be transmitted according to the timing advance associated with the determined non-terrestrial radio network node. The operations may further comprise avoiding flushing of the context information from the memory of the user equipment and avoiding performing of random access with respect to the determined non-terrestrial radio network node to facilitate the conducting of the communication session with the determined non-terrestrial radio network node.

In an embodiment, the determining to transfer the communication session from the serving terrestrial radio network node to the determined non-terrestrial radio network node may further comprise determining that a communication link between the user equipment and the serving terrestrial radio network node corresponding to the communication session has failed and determining a nonexistence of terrestrial radio nodes, other than the serving terrestrial radio network node, to which the user equipment is able to be handed over to facilitate the communication session. The determining to transfer the communication session may further comprise determining that the determined non-terrestrial radio network node corresponds to a higher signal strength measurement than one or more signal strength measurements corresponding to one or more non-terrestrial radio network nodes other than the determined non-terrestrial radio network node.

In an embodiment, the communication session between the user equipment and the serving terrestrial radio network node may be associated with a session quality of service, wherein the link recovery configuration further comprises a resource indication indicative of at least one non-terrestrial resource, corresponding to the determined non-terrestrial radio network node, usable by the user equipment for the conducting of the communication session, and wherein the at least one non-terrestrial resource is capable of facilitating the communication session according to the session quality of service.

### BRIEF DESCRIPTION OF THE DRAWINGS

FIG. 1 illustrates wireless communication system environment.

FIG. 2 illustrates an environment with a satellite base station and satellite that are capable of communication of traffic corresponding to a radio access network.

FIG. 3 illustrates an example environment with a terrestrial radio access network node, facilitating a communication session with a user equipment, determining to facilitate transfer the session to a non-terrestrial network node.

FIG. 4 illustrates an example adaptive session transfer configuration.

FIG. 5 illustrates an example environment with a user equipment, conducting a communication session with a terrestrial network node, determining to transfer the communication session to a non-terrestrial network node.

FIG. 6 illustrates an example link recovery configuration.

FIG. 7 illustrates a timing diagram of an example embodiment of a terrestrial network node determining to facilitate transfer of a communication session to a non-terrestrial network node.

FIG. 8 illustrates a timing diagram of an example embodiment of a user equipment determining to transfer a communication session from a terrestrial network node to a non-terrestrial network node.

FIG. 9 illustrates a flow diagram of an example embodiment method.

FIG. 10 illustrates a block diagram of an example method embodiment.

FIG. 11 illustrates a block diagram of an example first radio network node.

FIG. 12 illustrates a block diagram of an example non-transitory machine-readable medium embodiment.

FIG. 13 illustrates an example computer environment.

FIG. 14 illustrates a block diagram of an example wireless user equipment.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

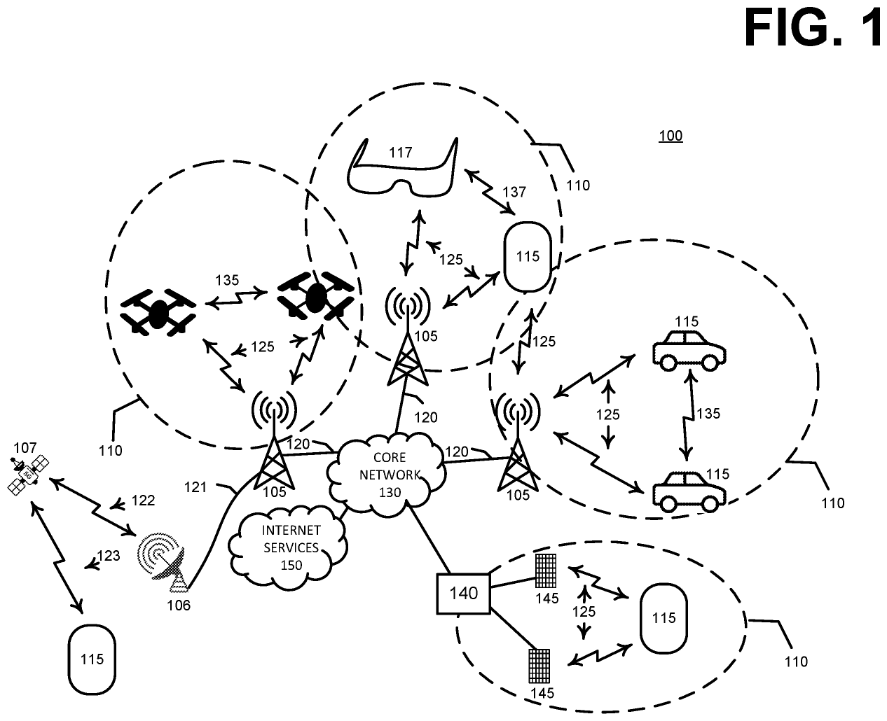

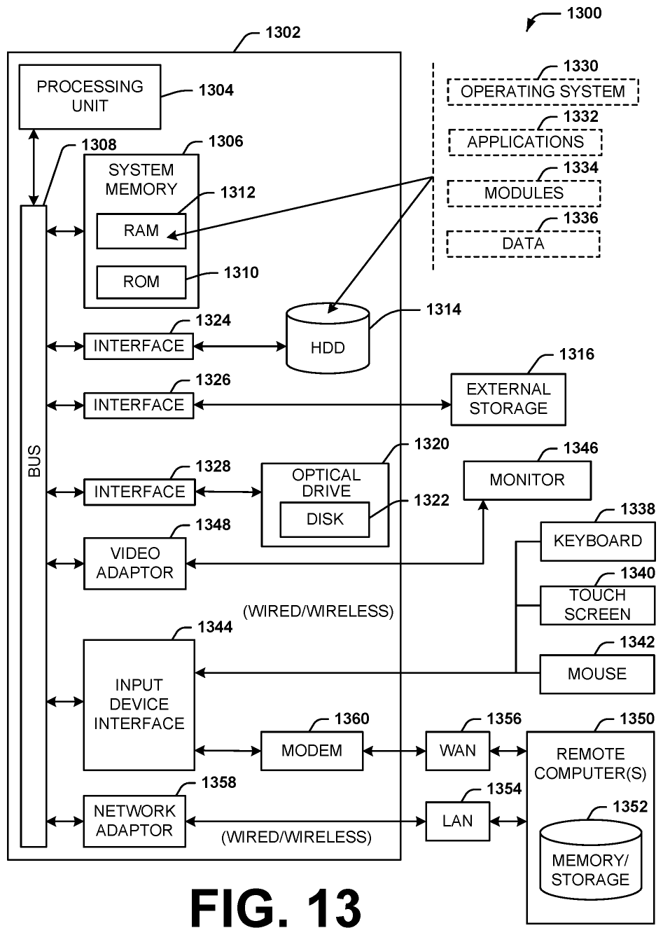

Turning now to the figures, FIG. 1 illustrates an example of a wireless communication system 100 that supports blind decoding of PDCCH candidates or search spaces in accordance with aspects of the present disclosure. The wireless communication system 100 may include one or more base stations 105, one or more UEs 115, and core network 130. In some examples, the wireless communication system 100 may be a Long Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality headset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 13.

Continuing with discussion of FIG. 1, base stations 105 may be dispersed throughout a geographic area to form the wireless communication system 100 and may be devices in different forms or having different capabilities. Base stations 105 and UEs 115 may wirelessly communicate via one or more communication links 125. A base station 105 may be referred to as a RAN node. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, a wireless transmit receive unit (“WTRU”), or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, an end extended reality appliance, an extended reality processing unit, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one or more component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The evolution of communication networks has witnessed remarkable advancements over the past decades. A significant extension of 5G's potential may lie beyond the conventional terrestrial infrastructure, giving rise to what are known as 5G Non-Terrestrial Networks (“NTN”).

Non-Terrestrial Networks may encompass a diverse range of technologies and architectures that may comprise space-based, airborne, and maritime platforms to enhance global communication capabilities. Integration of 5G and non-terrestrial environments may facilitate connectivity being established, maintained, and optimized to remote and underserved regions.

Satellites equipped with 5G capabilities constitute an aspect of 5G NTN. Satellites, positioned in low Earth orbit (“LEO”), medium Earth orbit (“MEO”), or geostationary orbit (“GEO”), may form an intricate web of interconnected nodes. The satellites can provide widespread coverage, offering high-speed data connections, low latency communication, and global mobility. Satellites may facilitate broadband access in rural and remote areas, disaster-stricken regions, and on moving vehicles, ships, and aircraft, thus bridging the digital divide.

Satellite-based NTN can bridge connectivity gaps in remote and rural areas, provide disaster recovery communication, and offer enhanced coverage for maritime and aeronautical services. High-altitude platforms and drones equipped with cellular capabilities can serve as temporary network relays for events, emergencies, or areas with signal-strength coverage deficiencies. such applications may benefit not only traditional voice and data services but also for technologies, such as, for example, Internet of Things (“IoT”), wherein connectivity is typically a desirable, or a fundamental requirement.

A non-terrestrial base station 106, which may comprise a satellite antenna, may be coupled to core network 130. Non-terrestrial base station 106 may communicate with satellite 107, which may communicate with a user equipment 115. Non-terrestrial base station 106, which may be referred to as a non-terrestrial network gateway, and satellite 107 may facilitate delivering traffic corresponding to a radio access network, which may comprise RAN nodes 105, core network 130, backhaul links 120, and long-range wireless links 125, to user equipment that may be located beyond coverage of a RAN node 105. Links 121 between RAN nodes 105 and satellite base station/gateway 106 may comprise coaxial, fiber, or wireless links that may be similar to links 120. Links 122 to satellite node 107 and links 123 from satellite/node 107 to UE 115 may comprise line-of-sight microwave signal transmission. A UE 115 may be configured with at least one antenna, or at least one processor, to facilitate transmitting or receiving microwave signals to/from satellite node 107. Description of herein, or reference to herein, a radio node or a radio network node may be a description or a reference to either a terrestrial RAN node 105, a non-terrestrial gateway 106, a non-terrestrial satellite node 107, or a combination of one or more of a terrestrial RAN node, a non-terrestrial gateway, or a non-terrestrial satellite. A terrestrial network node may be referred to as a “TN” node. Reference to a satellite node, or a non-terrestrial network node, may comprise a reference to satellite 107, base station gateway 106, or a combination of satellite 107 and base station/gateway 106.

It will be appreciated that although an NTN node may benefit the most from embodiments disclosed herein, techniques disclosed herein may be of benefit to a ground-based RAN node. Thus, use of “radio network node” may be interpreted as referring to a ground-based RAN node or to a satellite node, which may comprise a gateway 106 or a satellite 107.

NTNs can enhance the limited coverage of ground RANs, which makes NTNs cost efficient in remote rural areas, mountainous areas, and generally where ground cellular deployments are either not possible or not cost efficient. Embodiments described herein in may facilitate dynamic and seamless recovery, via available NTNs (e.g., accessible by a user equipment), of an existing communication session being conducted via a TN radio link that may fail. A TN radio link failure may occur due to lack of TN ground coverage (e.g., lack of adequate signal strength) corresponding to a geographic region in which a user equipment associated with an existing communication session is located. According to conventional techniques, when a user equipment experiences a ground/TN radio link coverage failure, the user equipment may attempt to search for adjacent terrestrial RAN nodes/cells for connection re-establishment. However, in case of no available ground coverage corresponding to another terrestrial RAN node/cell, the user equipment may experience a final link radio failure and may terminate and flush all existing session context information, regardless of availability of satellite/NTN coverage. Embodiments described herein may facilitate seamless session transfer and resumption, and device context information transfer from a ground network to a satellite network, in case of a potential ground radio link failure, thus avoiding the need of establishing a brand-new cellular connection and losing context and data information corresponding to the session. Embodiments disclosed herein may facilitate dynamically recovering session information via an NTN node path.

According to conventional techniques, if another terrestrial RAN node is available to facilitate the existing communication session with the user equipment, the communication session may be completely terminated, and end user experience may be severely impacted. Conventional techniques however lack support for seamless device context retrieval and adaptive TN-to-NTN session resumption, and therefore according to conventional techniques, regardless of NTN coverage availability, due to non-integration of TN to NTN radio link recovery procedures an existing communication session context is not transferred from a TN node to an NTN node that may be capable of facilitating a communication session with a user equipment.

According to embodiments described herein, an adaptive and seamless TN-to-NTN session transfer procedure facilitates transfer of a communication session, and associated context information, from a TN node to an NTN node such that an NTN-capable user equipment is capable of seamlessly recovering and dynamically resuming, via an available NTN, a session that was previously being facilitated via a TN radio link that failed. Novel TN RAN behaviors are described herein that facilitate dynamic TN to NTN session transfer along with description of associated novel TN/ground signaling procedures and configuration information.

Conventional techniques do not facilitate TN/ground RAN session transfer towards an available NTN node without triggering a measured handover. According to conventional techniques, a source TN RAN node only transfers device context information towards a target RAN node to which the device is being handed over. Conventional techniques do not facilitate transferring session context information. Embodiments described herein may facilitate transferring device specific and/or device-group-common session information toward a target NTN node, or to a RAN node (to which the device may not be directly handed over) that may be communicatively coupled with a gateway to which a target NTN node is connected.

According to conventional techniques an active communication session is fully terminated when a current radio link facilitating the communication session fails and other RAN nodes in proximity of the currently serving RAN node are not available with an acceptable measured coverage/signals strength. Embodiments described herein may facilitate NTN-capable user equipment devices dynamically resuming a communication session, which was being facilitated by a since-failed ground radio link corresponding to a source/serving RAN node, via an NTN node for which a coverage level may not have been measured by the user equipment. The NTN node may be directly instructed to resume the session previously facilitated by the failed ground radio link based on a coverage level corresponding to the NTN node being essentially uniform, and thus ‘known’, with respect to most, if not all, NTN-capable user equipment devices in proximity of the source RAN node. Novel transfer of session context information and corresponding retrieval procedures may be device specific or device-group-specific because the novel session context information retrieval is related to a communication session itself instead of being related just to a single device with which the session was/is being conducted. Thus, unlike with conventional techniques, a communication session that may be transferred from a TN RAN node to an NTN node according to embodiments disclosed herein may be associated with multiple devices that correspond to an active session.

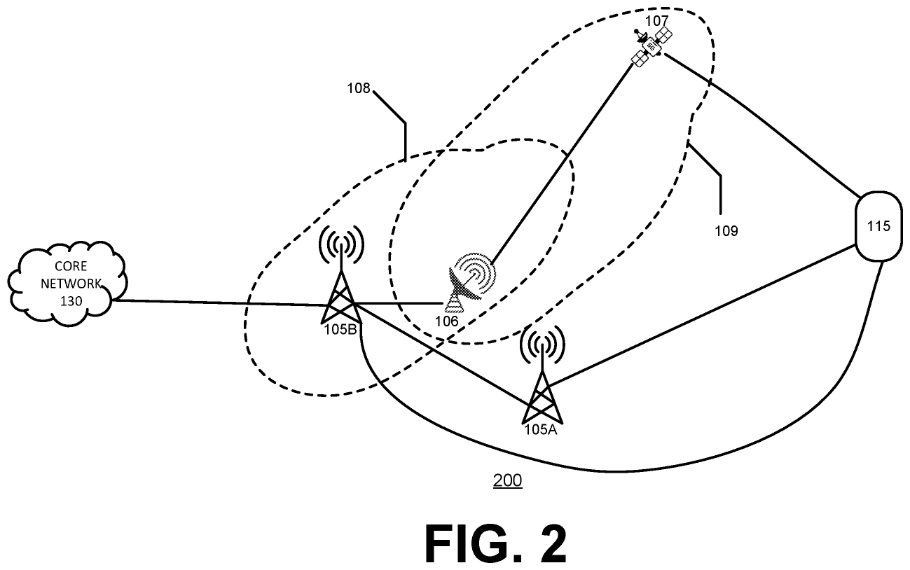

Turning now to FIG. 2, the figure illustrates ground-based RAN node 105A, base station 106, and NTN node 107, any one or more of which may be referred to as a radio network node. In reference to some embodiments disclosed herein, reference to a TN node may comprise a reference to node 108, which may comprise one or more of terrestrial RAN node 105A or gateway 106. In reference to some embodiments disclosed herein, reference to an NTN node may comprise a reference to node 109, which may comprise one or more of gateway 106 or satellite 107. In some embodiments, a communication session with UE 115 may be served by RAN node 105A. However, in some embodiments a communication session with UE 115 may be served by RAN node 105B, which may transfer session context information corresponding to the session to RAN node 105A for relaying toward satellite NTN node 107 directly, or via gateway 106.

### Adaptive Terrestrial and Non-Terrestrial Session Transfer.

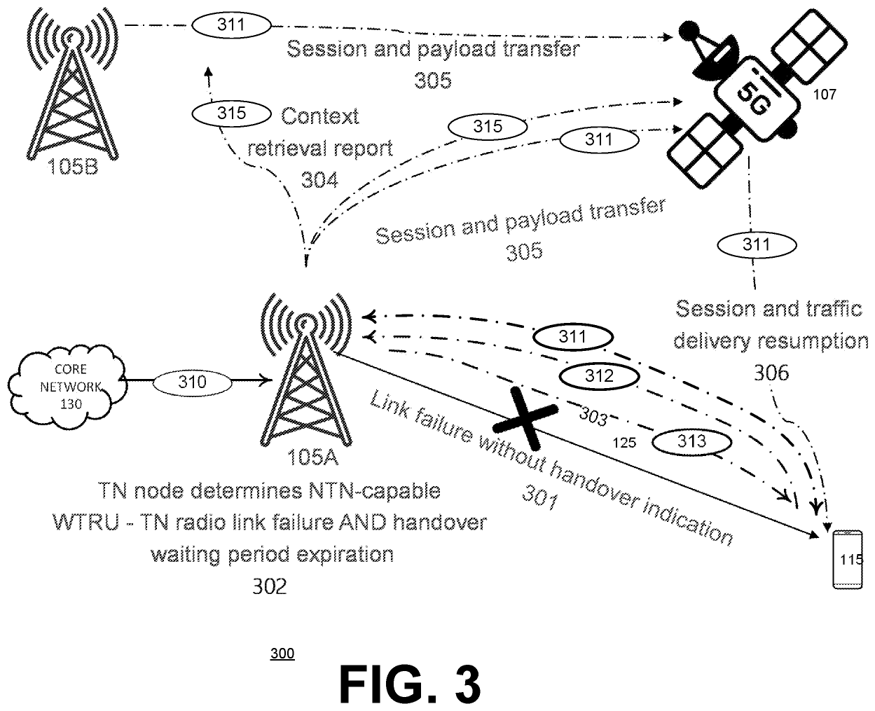

Turning now to FIG. 3, terrestrial network node 105A may receive, or may have already received, from core network via backhaul links, a non-terrestrial network adaptive session transfer configuration 310. RAN node 105A may receive configuration 310 before or after a failure of link 125 between user equipment 115 and node 105A that may occur at act 301. Link 125, corresponding to the link failure that may occur at act 301, may be currently used to facilitate delivery of active, or existing, communication session 311 between UE 115 and RAN node 105A. Adaptive session transfer configuration 310 may comprise any of the following information elements: a minimum coverage threshold, which may be specified by a criterion, usable by RAN node 105A for triggering transmission of a TN-NTN session transfer configuration, which may be referred to as a link recovery configuration 313; or a maximum number of radio link failures without inter-TN-RAN node handover of UE 115 during a configured sample period or length of time. A configured link failure threshold may be used by receiving TN RAN node 105A to trigger transmitting a link recovery configuration 313 to a user equipment, such as UE 115, with respect to which the configured number of link failures has occurred during a period, length of time, or time window of length equal to the configured period/length of time during which link failures are sampled/determined and analyzed with respect to the configured link failure number specified by the criterion.

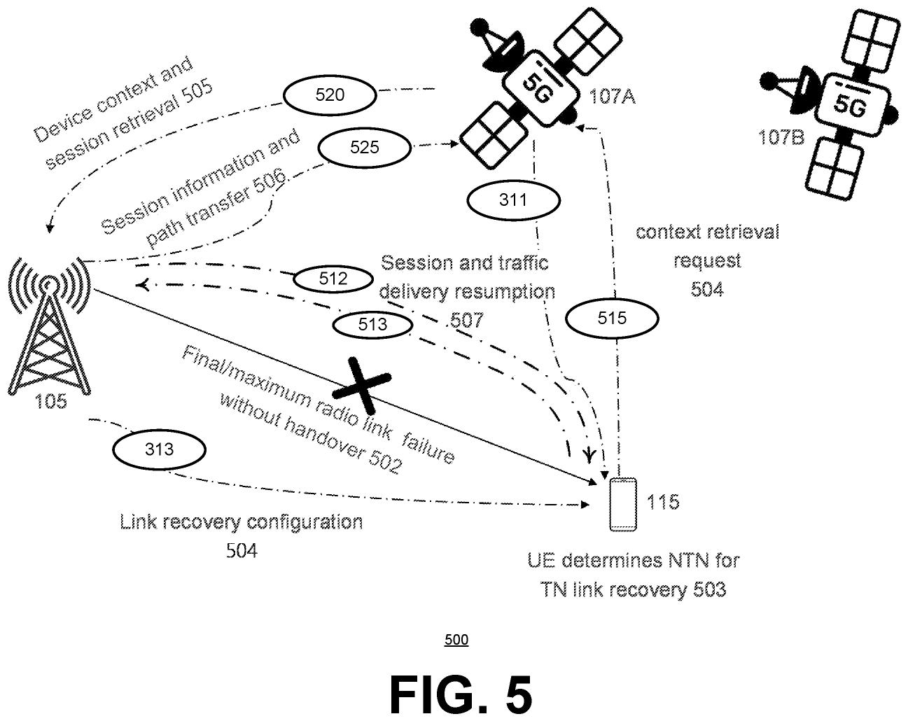

At act 302, on condition of receiving a radio parameter measurement report 312 comprising an indication of at least one radio characteristic, for example a signal strength indication indicative of a signal strength corresponding to a signal received by UE 115 from RAN node 105A, RAN node 105A may determine that a signal strength indicated in report 312 satisfies a configured minimum coverage threshold level applicable to determining to cause an adaptive NTN session transfer of communication session 311. At act 302, instead of determining from a report 312 that a signal strength, corresponding to RAN node 105A, determined by UE 115, has dropped below a configured threshold value, on condition of determining, by RAN node 105A, a number of radio link failures with UE 115 that exceeds, or otherwise satisfies, at least one session transfer criterion included in, or indicated by an indication in, configuration 310, which at least one session transfer criterion may be a maximum threshold, or number, of link failures that occur between UE 115 and RAN node 105A during a configured sample period (e.g., configured via configuration 310), TN RAN node 105A may determine to transmit a TN-NTN session link recovery configuration 313 towards WTRU/UE 115. Configuration information 313 may comprise any one or more of the following information elements: one or more target NTN identifiers corresponding to NTN nodes, for example node 107, that may facilitate seamless link recovery/session recovery of session 311; a device-specific context retrieval indication, or identifier, that may correspond to session context information associated with session 311; one or more NTN-node-specific timing advance value indication(s) indicative of timing advance values usable by UE 115 to establish communication with a NTN node corresponding to an identified NTN node, for example node 107; or one or more indication(s) of one or more NTN-specific uplink control search space(s) or one or more TN-NTN-shared uplink control search space(s) indicative of predefined search spaces, via which seamless link recovery request(s), such as a session transfer request message 513 described in reference to FIG. 5, can be transmitted towards an NTN node, which may be indicated by an NTN identifier indicated in configuration 313, that is to facilitate delivery, with respect to UE 115, traffic corresponding to session 311. TN node 105A may transmit link recovery configuration 313 to UE at act 303.

Continuing with description of FIG. 3, at act 304, on condition of having determined that NTN-capable WTRU/UE 115 has experienced TN radio link failure that corresponds to satisfaction of a maximum number of link failures and a handover waiting period has expired (e.g., a handover period that corresponds to UE 115 being potentially handed over to another TN RAN node 105), TN RAN node 105A may compile a context retrieval report 315, which may including capability information indicative of a capability of UE 115 (e.g., capability to communicate with NTN node 107, battery capability, processing capability, and the like), encryption information corresponding to UE 115, pending packet re-transmission information corresponding to session 311, or actual buffered payload corresponding to session 311 that is buffered for scheduling and transmission to UE 115.

On condition of availability of an active connection towards an NTN-gateway associated with an NTN node, for example gateway 106 as described in reference to FIG. 2, TN RAN node 105A may transmit a compiled WTRU context retrieval report 315 toward the active NTN gateway via backhaul links, for further transmission by the gateway to a corresponding NTN node, for example node 107 shown in FIG. 3. (It will be appreciated that a gateway capable of communicating with node 107 is not shown in FIG. 3.) It will be appreciated that in some embodiments, TN RAN node 105A may be capable of communicating directly with an NTN node 107 without use of an intervening gateway 106. Context retrieval report 315 may be transmitted to node 107 via a gateway associated with node 107 if RAN node 105A is communicatively coupled with, or otherwise associated with, the gateway, or context retrieval report 315 may be transmitted to another TN RAN node, for example node 105B, if the other TN RAN node is communicatively coupled with a gateway that is capable of communicating with node 107 but TN RAN node 105A is not communicatively coupled with a gateway that is capable of communicating with node 107. If an active connection towards an NTN-gateway is not available, either directly with or via another TN RAN node, TN RAN node may transmit a compiled WTRU context retrieval report 315 toward core network 130 for delivery thereby to one or more TN RAN node(s) that may have an active connection with an NTN gateway. Thus, TN RAN node 105A is able to dynamically and proactively facilitate transfer of failed TN radio communication session 311 to be resumed via NTN node 107.

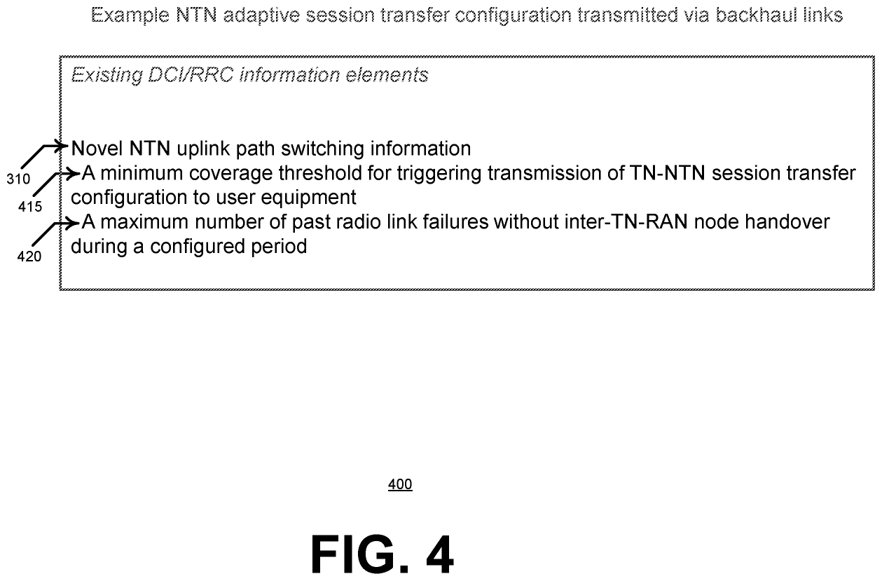

Turning now to FIG. 4, the figure illustrates an example adaptive session transfer configuration message 400 comprising adaptive session transfer configuration information 310 described in reference to FIG. 3. Configuration information 310 may comprise a minimum coverage threshold/criterion value contained in field 415. A value, or function, indicated in field 415 may be referred to as a session transfer criterion. The minimum coverage criterion may be used to trigger transmission of a TN-NTN session link recovery configuration 313 to a user equipment that has reported, via a report 312, a signal strength corresponding to a serving RAN node that falls below a configured criterion value contained in field 415. For example, a RAN node serving a user equipment may analyze a signal strength reported by the user equipment in a report 312 with respect to a criterion value contained in field 415. In an example wherein a TN RAN node is facilitating an existing communication session with a user equipment, a signal strength reported by the user equipment in a report 312 being less that, or equal to, a session transfer criterion value configured in field 415 may correspond to satisfaction of the at least one session transfer criterion. Satisfaction of the session transfer value configured in field 415 may result in the TN RAN node, which may be performing the analysis of the reported signal strength with respect to the configured session transfer criterion, transmitting, to the user equipment, context information, corresponding to the existing communication session that is to be transferred from delivery of traffic assisted therewith being facilitated by the TN RAN node to delivery of the traffic being facilitated by an NTN node. The context information transmitted by the TN RAN node to the user equipment may be usable by the user equipment to facilitate continuance of the existing communication session with the NTN node.

Configuration information 310 may comprise in field 420 a radio link failure criterion, which may be a maximum number of radio link failures between a TN RAN node and a user equipment. A criterion value contained in field 420 may be analyzed with respect to a configured handover period by a serving RAN node that may be facilitating delivery of an existing communication session with a user equipment. Analyzing a number of radio link failures with respect to a handover period may minimize attempting to transfer an existing communication session from a TN RAN node to an NTN node when the user equipment is being handed over from the serving TN RAN node to another TN RAN node according to conventional handover techniques. If a configured handover period, which may begin when a radio link failure equals a number configured via field 420 in configuration 310, expires without the user equipment, or the existing communication session corresponding thereto, being handed over to a TN RAN node, the serving TN RAN node may determine to initiate facilitation of transfer of the existing communication session to an NTN node. Initiating facilitation of transfer of the existing communication session may comprise the TN RAN node that is currently facilitating delivery of the existing communication session facilitating transmission of a link recovery configuration 313 to the user equipment corresponding to the existing communication session. Initiating facilitation of transfer by the serving TN RAN of the existing communication session may also comprise the serving TN RAN node compiling and transmitting a context retrieval report 315 to another TN RAN node, a gateway, or an NTN node as described in reference to FIG. 3. The user equipment may use information contained in link recovery configuration 313 to request delivery of traffic corresponding to the existing communication being transferred as described in reference to FIG. 5.

### Seamless Terrestrial and Non-Terrestrial Link Recovery.

Turning now to FIG. 5, NTN-capable user equipment device 115 may receive a TN-to-NTN seamless link recovery configuration 313 that may comprise one or more of the following information elements: NTN or satellite identification information corresponding to NTN node(s) 107 that may be configured to facilitate transmission of a communication session with a ground RAN node 105 being dynamically resumed and/or recovered after one or more potential ground/TN radio link failure(s) without ground handover occurring; one or more device-specific and/or device-group-common context identifier(s)/indication(s) indicative of context information corresponding to ground UE device 115 or device-group, stored by a last serving TN-RAN node 105 that has/had been facilitating a communication session 311 between the TN-RAN node and UE 115 (or a group of user equipment of which UE 115 is a member); one or more NTN-node-specific timing advance level(s), or value(s); or one or more indication(s) of uplink control channel resource occasion(s) that may be NTN node specific, NTN group common, and/or shared among TN and NTN RAN nodes, and via which NTN capable devices, such as UE 115, corresponding to failed TN radio links, can use to transmit associated context and link retrieval requests 515 towards one or more target NTNs.

At act 503, on condition of NTN-capable user equipment device 115 experiencing a ground RAN radio link failure, wherein another adjacent TN RAN node that could facilitate delivery of traffic corresponding to session is not available, user equipment 115 may determine an NTN node identifier, from a list of NTNs for TN link recovery that may be contained in configuration 313, that may correspond to a best/highest received coverage at UE 115 with respect to coverage/signal strengths of other NTN nodes identified in configuration 313. For example, node 107A may correspond to a higher signal strength, determined by UE 115, than node 107B. Accordingly, at act 504, NTN-capable UE 115 may transmit a session transfer request message 515 to request recovery of session 311, which request message may be referred to as a link retrieval request, towards determined NTN node 107A via a first available configured uplink control channel resource corresponding to NTN node 107A that is usable to facilitate TN radio link/session recovery. Request 515 may comprise a context information identifier indicated in configuration 313 and corresponding to session 311 that may be usable by non-terrestrial network node 107A to request obtaining, via context retrieval request 520, context information 525 corresponding to session 311.

At act 505, on condition of receiving a context retrieval request 515 and an associated context identifier from an NTN capable device, NTN node 107A may transmit a downlink ground context retrieval and path switching request 520 toward TN RAN node 105, or toward a gateway communicatively coupled thereto. Responsive to transmitting request 520, at act 506 NTN node 107A may receive context information 525, or device-group context information, from TN RAN node 105, or from a gateway coupled with TN RAN node 105. Accordingly, because context information 525, which may include session context information corresponding to communication session 311, may be maintained by RAN node 105 and may be transferred thereby to NTN node 107A in response to, or based on, a context information identifier, contained in request 520, that is indicative of the context information corresponding to communication session 311, pending and new traffic payload associated with communication session 311 may be path-switched from being served by RAN node 105 to being served by NTN RAN node 107A. The transferring of facilitation of delivery of traffic corresponding to communication session 311 from TN RAN node 105 to NTN node 107A may be performed without user equipment 115 flushing context information corresponding to the communication session or without the user equipment transmitting a random access preamble to non-terrestrial network node 107A and performing random access procedures with NTN node 107A before the conducting of the communication session between the user equipment and the non-terrestrial network node 107A. At act 507, NTN capable user equipment 115 may resume session 311 that was halted due to a radio link failure at act 503, via determined NTN node 107A.

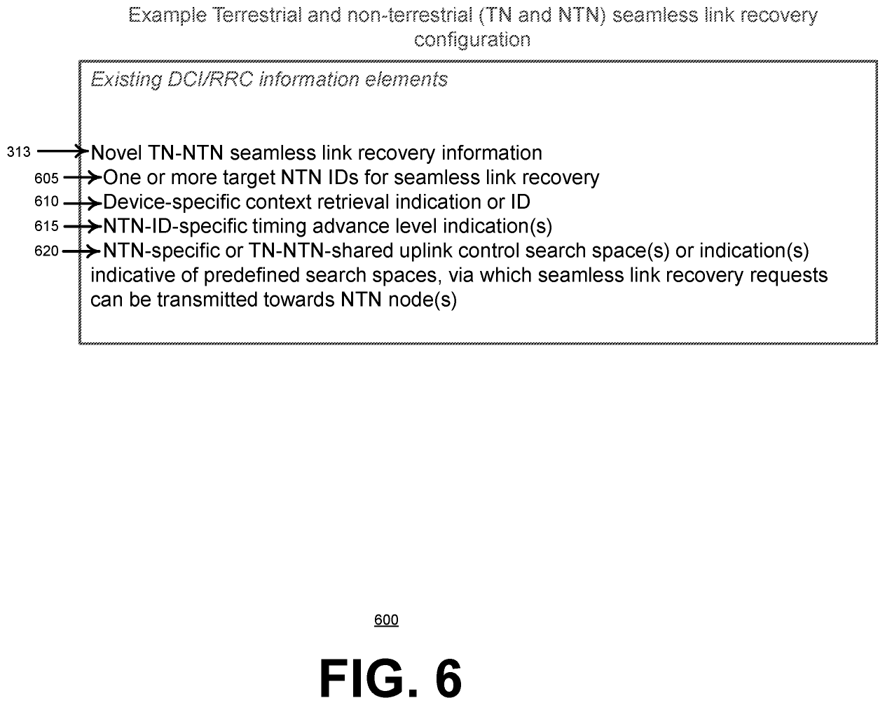

Turning now to FIG. 6, the figure illustrates an example link recovery configuration message 600 comprising link recovery configuration information 313 described in reference to FIGS. 3 and 5. Link recovery configuration information 313 may comprise a non-terrestrial node identifier field 605. One or more non-terrestrial node identifiers respectively corresponding to one or more network nodes that may be potential targets for transfer of a communication session may be included in field 605. Field 610 may comprise a device specific context information identifier which may be used by a user equipment that receives configuration 315 to request transfer of a communication session from a terrestrial radio access network node that is currently serving the communication session to a non-terrestrial network node corresponding to an identifier contained in field 605. Thus, field 610 may comprise a context identifier that may be used to facilitate transferring context information from a currently serving radio access network node to a non-terrestrial network node. By transferring context information corresponding to an existing communication session the communication session may be transferred from the terrestrial radio access network node to the non-terrestrial network node without the user equipment that corresponds to the communication session having to flush session context information and without the user equipment having to perform random access procedures with respect to the non-terrestrial network node. Field 615 may comprise one or more timing advance values, or indications, indicative of one or more timing advance values, respectively corresponding to the one or more non terrestrial network nodes indicated in field 605. Accordingly, a user equipment that may request transfer of an existing communication session by transmitting a context identifier contained in field 610 to a non-terrestrial network node may use a timing advance value indicated in field 615 to transmit to a corresponding NTN node a message that may comprise a context identifier contained in 610. Using a timing advance value indicated in field 615 may facilitate avoiding a user equipment having to transmit a random access preamble to the non-terrestrial network node. Field 620 may comprise information corresponding to, or indicative of, a non-terrestrial resource, for example a search space and time or frequency resource information corresponding to the search space, usable to transmit a message that may comprise a context identifier contained in field 610. Thus, although the user equipment may not have previously established a communication session with a non-terrestrial network node identified in field 605, the user equipment may nevertheless resume a communication session, which was previously facilitated by a terrestrial radio access network node, seamlessly (e.g., the user equipment already has a timing advance value and uplink resource information usable to transmit a session transfer request and the non-terrestrial network node retrieves context information corresponding to the existing session based on a context identifier transmitted to the non-terrestrial network node according to the timing advanced value and uplink resource information).

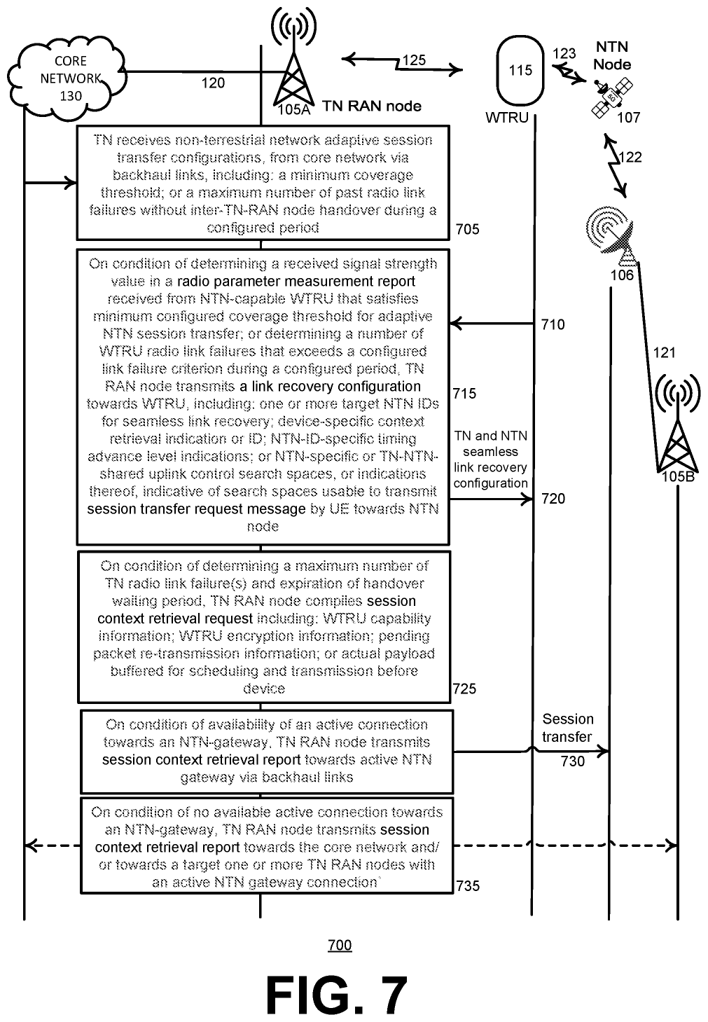

Turning now to FIG. 7, the figure illustrates a timing diagram of an example embodiment method 700. At act 705, terrestrial network node 107 may receive a non-terrestrial network adaptive session transfer configuration. The non-terrestrial network adaptive session transfer configuration may be received from computing equipment of core network 130 via backhaul links 120 that may couple the core network to RAN nodes 105A and 105B. The non terrestrial network adaptive session transfer configuration may comprise any of the following information elements: (1) a minimum coverage threshold for triggering transmission to UE 115 of a TN-NTN session transfer configuration, which may be referred to as a link recovery configuration; or (2) a maximum number of past radio link failures without inter-TN-RAN node handover over a predefined trailing period of time. At act 715, on condition of determining that a received coverage signal strength indication in a user equipment radio parameter measurement report received at act 710 from NTN-capable WTRU/UE 115 satisfies a minimum configured coverage threshold for adaptive NTN session transfer, or determining a number of WTRU radio link failures that exceeds a configured maximum threshold of link failures during a configured trailing amount of time, TN RAN 105A node may transmit at act 720 a TN-NTN session transfer configuration, which may be referred to as a link recovery configuration, towards WTRU/UE 115. The TN-NTN session transfer configuration may including any of the following information elements: (1) one or more NTN identifiers, associated with one or more potential target NTN nodes, usable for seamless link/session recovery; (2) device-specific context retrieval indication or ID; (3) NTN-ID-specific timing advance level indications; or (4) indications of one or more NTN-specific, or TN-NTN-shared, uplink control search space resource(s), via which seamless link recovery requests, such as a request 515 shown in FIG. 5, can be transmitted towards a target NTN node 107 identified in the TN-NTN session transfer configuration. On condition of determining NTN-capable WTRU/UE 115 is experiencing a radio link failure with respect to TN RAN node 105A and determining that a handover waiting period has expired, TN RAN node 105A may compile at act 725 a WTRU context retrieval report, for example report 315 described in reference to FIG. 3, that may include capability information corresponding to UE 115, encryption information corresponding to UE 115, pending packet re-transmission information and actual buffered payload, buffered for scheduling and transmission, corresponding to an existing communication session between RAN node 105A and UE 115. On condition of availability of an active connection towards an NTN-gateway, TN RAN node 105A may transmit, at act 730, the compiled WTRU context retrieval report towards active NTN gateway 106, via backhaul links. On condition of no available active connection towards an NTN-gateway, TN RAN node 105A may transmit at act 735 the compiled WTRU context retrieval report towards core network 130 or towards another TN RAN node 105B, which may be communicatively coupled with gateway 106 and which may forward the compiled WTRU context retrieval report towards NTN node 107. NTN node 107 may use information in WTRU context retrieval report to facilitate delivery of an existing communication session with UE 116 that has been transferred from being facilitated by RAN node 105A without UE 115 having to flush session context information associated with the existing communication session or without having to perform random access procedures with the NTN node before delivery of the existing communication session with respect to the user equipment can continue.

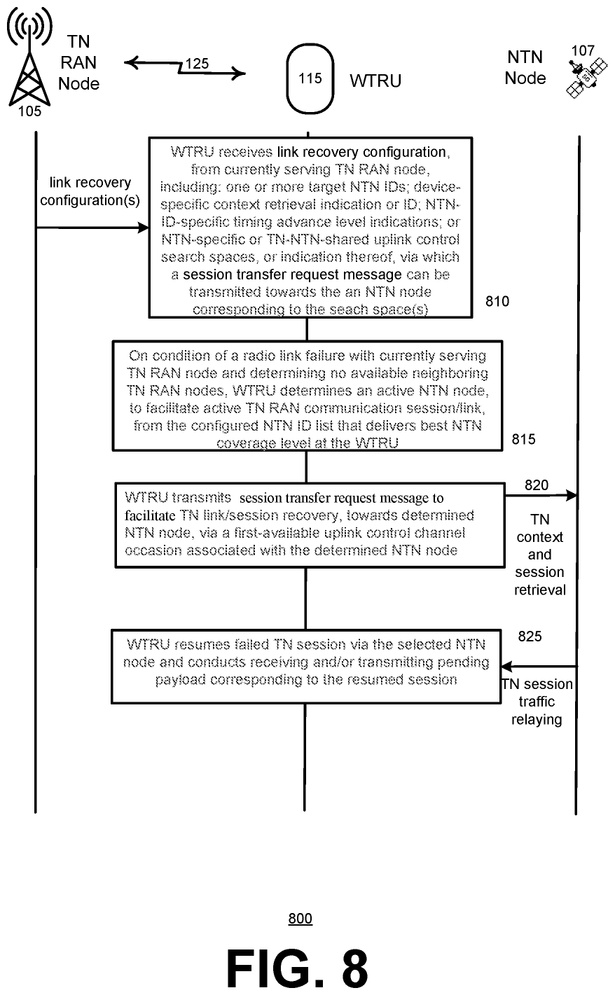

Turning now to FIG. 8, the figure illustrates a timing diagram of an example embodiment method 800. At act 805, WTRU/UE may receive a terrestrial and non-terrestrial (TN and NTN) seamless link recovery configuration, which may be referred to as a TN-NTN session transfer configuration or a link recovery configuration, from current serving TN RAN node 105. The link recovery configuration may comprise any of the following information elements: (1) one or more target NTN identifiers corresponding to one or more NTN nodes (e.g., NTN node 107) that may be capable of facilitating seamless transfer and recovery of an existing communication with UE 115 session currently being served by RAN node 105; (2) device-specific context retrieval indication/identifier; (3) NTN-ID-specific timing advance level indication(s) associated with one or more of the identified NTN node(s); or (4) one or more indications of one or more NTN-specific or TN-NTN-shared uplink control search space resources, or resource indications, indicative of predefined search spaces, via which a seamless link/session recovery request can be transmitted by UE 115 towards an NTN node identified in the configuration received at act 810.

At act 815, on condition of determining that a radio link failure with respect to current serving TN RAN node 105 has occurred, and on condition of determining that no neighboring TN RAN nodes are available that are capable of facilitating delivery of the existing communication session, WTRU/UE 115 may determine an active NTN node, from among the one or more NTN nodes identified in the configuration received at act 810, to recover the TN RAN link/session, based on being an NTN node of the identified NTN nodes that corresponds to the best signal strength coverage level determined by the WTRU/UE. At act 820, WTRU/UE 115 may transmit a context retrieval request, for example request 515 shown in FIG. 5, towards the NTN node determined at act 815, (e.g., NTN node 107) via a first available uplink control channel occasion resource, indicated in the configuration received at act 810, that is associated with NTN-assisted link/session recovery. At act 825, WTRU/UE 115 may resume conducting of the existing communication session, delivery of traffic corresponding to which was being facilitated by a radio link that the failed (e.g., link 125), via NTN node 107 determined at act 815, and may resume receiving and/or transmitting payload corresponding to the existing communication session without having to flush session context information corresponding to the existing communication session or without having to perform random access procedures with respect to NTN node 107.

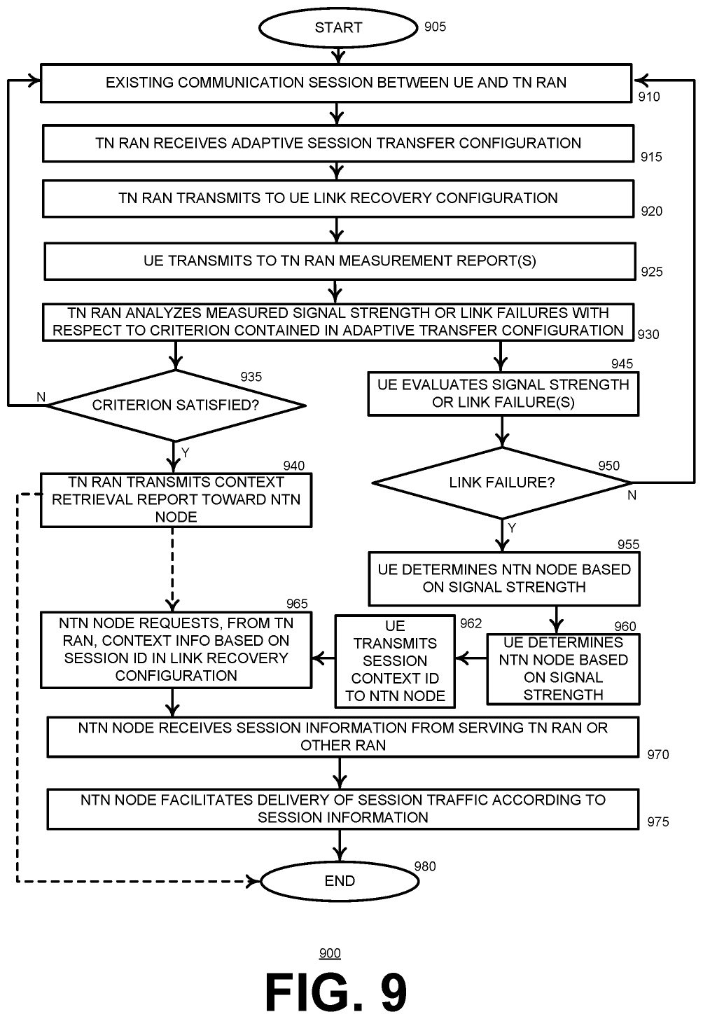

Turning now to FIG. 9, the figure illustrates a flow diagram of an example embodiment 900. Method 900 begins at act 905. At act 910, a communication session may be established, or may have been established, between a user equipment and a terrestrial radio access network node. At act 915, the terrestrial radio access network node may receive an adaptive session transfer configuration from network computing equipment, for example a component of a core network. At act 920, the terrestrial radio access network node may transmit to the user equipment a link recovery configuration, for example configuration 313 described in reference to FIG. 3. At act 925, which may occur during operation of the existing communication session, the user equipment may transmit to the terrestrial radio access network node one or more user equipment radio parameter measurement report(s), for example one or more reports 312 described in reference to FIG. 3. At act 930, the terrestrial radio access network node may analyze one or more measured signal strength values, which may have been indicated in one or more radio parameter measurement reports transmitted at act 925, with respect to a signal strength value criterion, or a signal coverage criterion, to determine whether the user equipment may be experiencing poor signal strength corresponding to the terrestrial radio access network node. At act 930, the terrestrial radio access network node may evaluate a number of link failures between the terrestrial radio access network node and the user equipment associated with radio links that may be facilitating the existing communication session or that may be facilitating other communication with respect to the user equipment. The result of the evaluation of the number of link failures may be a determined number of link failures. At act 935, a determination may be made by the terrestrial radio access network node whether the measured signal strength contained in radio parameter measurement reports or whether a determined number of radio link failures during a configured handover period correspond to satisfaction of one or more criterion/criteria, for example a signal strength criterion or a maximum number of radio link failures during a configured amount of time.

If a determination is made at act 935 that measured signal strength values or a determined number of link failures does not correspond to satisfaction of a configured criterion, which may be configured via the adaptive session transfer configuration received at act 915, method 900 may return to act 910 and the terrestrial radio access network node may continue to facilitate delivery of traffic corresponding to the existing communication session.

If, however, a determination is made by the terrestrial radio access network node at act 935 that a signal strength criterion or a radio link failure criterion is satisfied (e.g., one or more measured signal strength values reported in one or more radio parameter measurement reports equal or fall below a configured coverage criterion or a number of determined radio link failures during a hand over period equals or exceeds a configured link failure criterion), method 900 may advance to act 940. At act 940, the terrestrial radio access network node may compile and transmit a context retrieval report toward a non-terrestrial radio node. A context retrieval report may comprise one or more of: capability information, WTRU encryption information, pending packet re-transmission information, or actual buffered payload buffered for scheduling and transmission associated with the communication session existing or established at act 910. Output lines from block 940 illustrated in FIG. 9 are shown as dashed lines to indicate that after the terrestrial radio access network node transmits the context retrieval report toward the non-terrestrial radio node, the terrestrial radio access network node or the non-terrestrial radio node may pause, or may take no action, relative to transferring the communication session described in reference to act 910 if the user equipment does not request, or until the user equipment requests, transfer of the communication session to the non-terrestrial radio node. Accordingly, session context information contained in a context retrieval report may be available at a non-terrestrial radio node that may facilitate continuing delivery of traffic corresponding to the existing communication session, but if, for example, the user equipment does not request transfer of the communication session the non-terrestrial radio network node may not take further action with respect to the context information and method 900 may advance to act 980 and end.

Returning to description of act 930, after the terrestrial radio access network node may analyze measured signal strength values or a determine a number of link failures with respect to one or more criterion contained in the adapter session transfer configuration received at act 915, method 900 may advance to act 945. At act 945, the user equipment may evaluate signal strength values associated with one or more signals received from the terrestrial radio access network node. The user equipment may also determine that a radio link failure corresponding to a radio link that may be facilitating the communication session described in reference to act 910 has occurred and an alternative terrestrial radio access network node other than the serving terrestrial radio access network node that has been facilitating the existing communication session is not available or does not correspond to a signal strength value that may be sufficient to facilitate handover of the user equipment for facilitating of the existing communication session with the other terrestrial radio access network node. At act 950, if the user equipment determines that the serving terrestrial radio access network node that is currently facilitating delivery of traffic corresponding to the existing communication session is providing sufficient signal strength to continue facilitating the existing communication or that a link failure has not occurred that cannot be remedied by handover of the easier equipment to another terrestrial radio access network node, method 900 may return to act 910 and the existing communication session may be either facilitated by the current serving terrestrial radio access network node or the user equipment may be handed over, according to conventional techniques, to another terrestrial radio access network node for continuing facilitation of delivery of traffic corresponding to the existing communication session.

However, if the user equipment determines at act 950 that a link failure has occurred and that another neighboring terrestrial radio access network node is not available that can facilitate continuing facilitation of delivery of traffic corresponding to the existing communication session, 900 may advance to act 955. At act 955, the user equipment may determine a non-terrestrial radio network node, from one or more non-terrestrial radio network nodes indicated in the link recovery configuration transmitted by the current serving terrestrial radio access network node at act 920, to request continuing facilitation of delivery of traffic corresponding to the existing communication session. The user equipment may determine one or more signal strength values corresponding to one or more non-terrestrial radio network nodes indicated in the link recovery configuration transmitted at act 920, and the user equipment may determine at act 960 one of the indicated non-terrestrial radio network nodes that corresponds to a highest signal strength of the non-terrestrial radio access network nodes indicated in the link recovery configuration.

At act 962, the user equipment may transmit, to the non-terrestrial radio network node determined at act 960, a session transfer request message that may comprise a context information identifier, indicative of context information corresponding to the existing communication session, to be usable by the non-terrestrial radio network node to facilitate transfer of the existing communication being served by the non-terrestrial network node instead of the terrestrial radio access network node. The user equipment may use, as the context information identifier, a context information identifier included in the link recovery configuration transmitted by the terrestrial radio access network node at act 920. In an embodiment, the user equipment may use an identifier corresponding to the user equipment as the context information identifier. In an embodiment, the user equipment may use a session identifier corresponding to the existing communication session as the context information identifier. The user equipment may use a timing advance value or an uplink non terrestrial resource indicated in the link recovery configuration transmitted by the terrestrial radio access network node act 920 to transmit to the non-terrestrial radio network node the session context identifier at act 962 without having to perform random access procedures with respect to the non-terrestrial radio network node.

At act 965, the non-terrestrial network node, determined by the user equipment at act 960, may receive and use the context information identifier, transmitted by the user equipment at act 962, in a request, for example request 520 shown in FIG. 5, transmitted to the terrestrial radio network node that had been facilitating delivery of traffic corresponding to the existing communication session before a radio link failure or poor signal strength caused the user equipment to request transfer of the existing communication session to the non-terrestrial radio network node. The terrestrial radio access network node may receive the message containing the context information identifier transmitted at act 962 to determine and to transmit, toward the non-terrestrial radio network node, session context information corresponding to the existing communication session (e.g., session information 525 shown in FIG. 5). Responsive to transmitting to the terrestrial radio access network node the session transfer request at act 965, the non-terrestrial network node may receive at act 970 session context information from the serving terrestrial radio access network node (e.g., session information 525). It will be appreciated that if the terrestrial radio access network node that had been facilitating delivery of traffic corresponding to the existing communication session is not communicatively coupled to a satellite gateway (e.g., gateway 106 shown in FIGS. 1 and 2) that can communicate with the non-terrestrial network node, the terrestrial radio access network node may transmit the context session information associated with the existing communication session to another terrestrial radio access network node that may be communicatively coupled to a gateway, which may then forward the session context information to the non-terrestrial radio network node determined by the user equipment at act 960. At act 975, the non-terrestrial radio network node determined by the user equipment at act 960 may begin facilitating delivery of traffic corresponding to the existing communication session and according to the session context information received at 970 with the user equipment without the user equipment having had to flush session context information corresponding to the existing communication session and without the user equipment having to transmit a random access preamble and perform random access procedures with respect to the non-terrestrial radio network node determined at act 960. Method 900 advances to act 980 and ends.

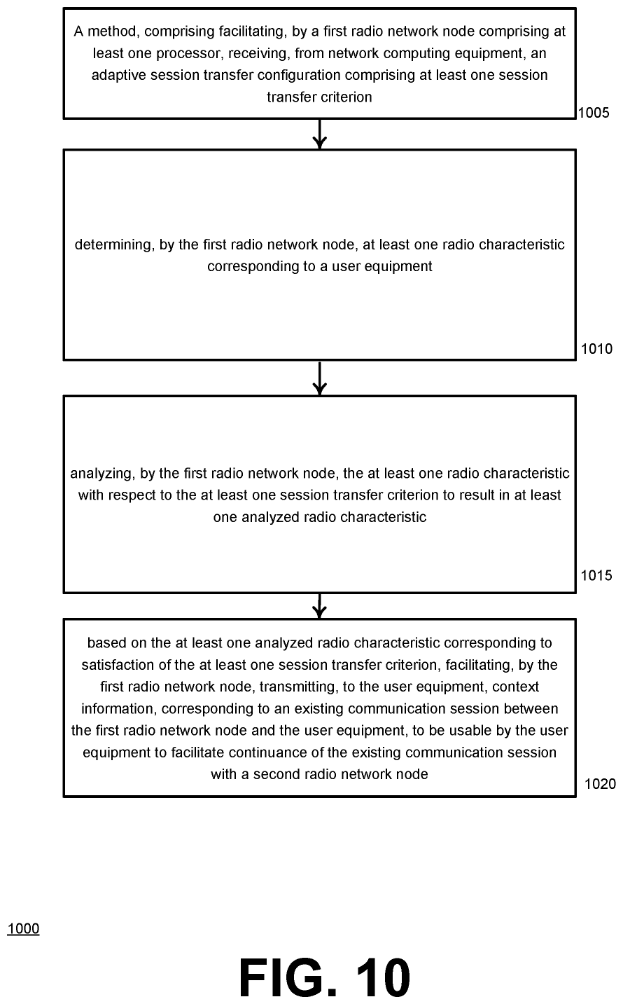

Turning now to FIG. 10, the figure illustrates an example embodiment method 1000 comprising at block 1005 facilitating, by a first radio network node comprising at least one processor, receiving, from network computing equipment, an adaptive session transfer configuration comprising at least one session transfer criterion; at block 1010 determining, by the first radio network node, at least one radio characteristic corresponding to a user equipment; at block 1015 analyzing, by the first radio network node, the at least one radio characteristic with respect to the at least one session transfer criterion to result in at least one analyzed radio characteristic; and at block 1020 based on the at least one analyzed radio characteristic corresponding to satisfaction of the at least one session transfer criterion, facilitating, by the first radio network node, transmitting, to the user equipment, context information, corresponding to an existing communication session between the first radio network node and the user equipment, to be usable by the user equipment to facilitate continuance of the existing communication session with a second radio network node.

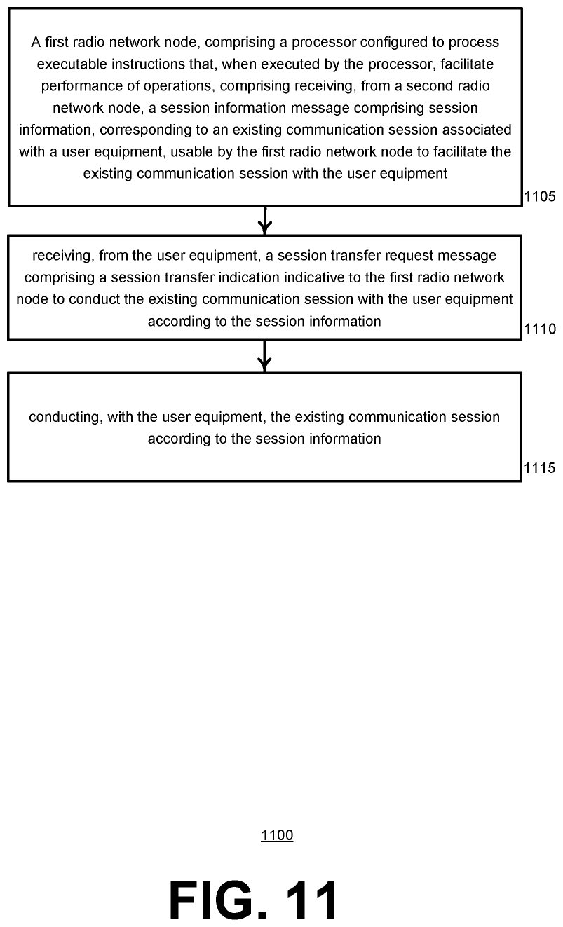

Turning now to FIG. 11, the figure illustrates an example first radio network node 1100, comprising at block 1105 a processor configured to process executable instructions that, when executed by the processor, facilitate performance of operations, comprising receiving, from a second radio network node, a session information message comprising session information, corresponding to an existing communication session associated with a user equipment, usable by the first radio network node to facilitate the existing communication session with the user equipment; at block 1110 receiving, from the user equipment, a session transfer request message comprising a session transfer indication indicative to the first radio network node to conduct the existing communication session with the user equipment according to the session information; and at block 1115 conducting, with the user equipment, the existing communication session according to the session information.

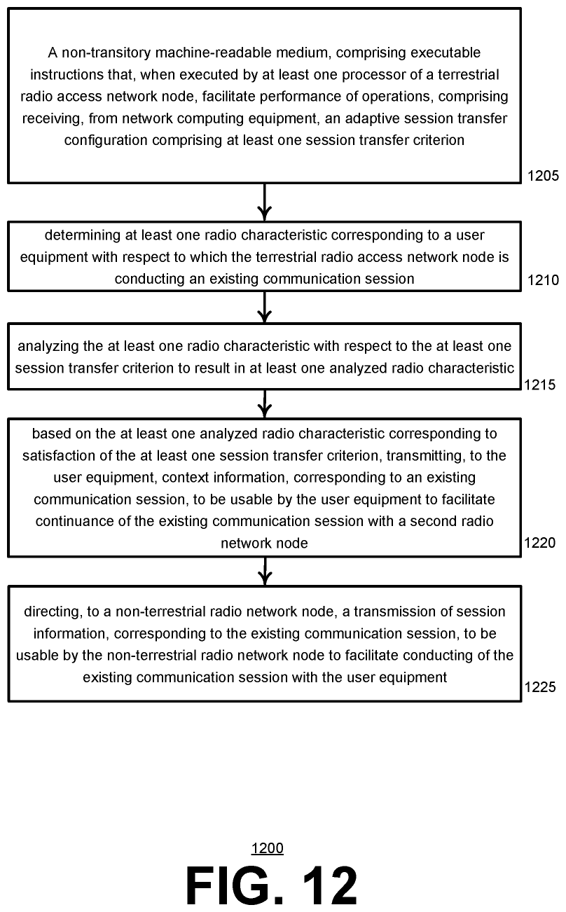

Turning now to FIG. 12, the figure illustrates a non-transitory machine-readable medium 1200 comprising at block 1205 executable instructions that, when executed by a processor of a terrestrial radio access network node, facilitate performance of operations, comprising receiving, from network computing equipment, an adaptive session transfer configuration comprising at least one session transfer criterion; at block 1210 determining at least one radio characteristic corresponding to a user equipment with respect to which the terrestrial radio access network node is conducting an existing communication session; at block 1215 analyzing the at least one radio characteristic with respect to the at least one session transfer criterion to result in at least one analyzed radio characteristic; at block 1220 based on the at least one analyzed radio characteristic corresponding to satisfaction of the at least one session transfer criterion, transmitting, to the user equipment, context information, corresponding to an existing communication session, to be usable by the user equipment to facilitate continuance of the existing communication session with a second radio network node; and at block 1225 directing, to a non-terrestrial radio network node, a transmission of session information, corresponding to the existing communication session, to be usable by the non-terrestrial radio network node to facilitate conducting of the existing communication session with the user equipment.

In order to provide additional context for various embodiments described herein, FIG. 13 and the following discussion are intended to provide a brief, general description of a suitable computing environment 1300 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors and may include a cache memory. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

Computer 1302 further includes an internal hard disk drive (HDD) 1314 (e.g., EIDE, SATA), one or more external storage devices 1316 (e.g., a magnetic floppy disk drive (FDD), a memory stick or flash drive reader, a memory card reader, etc.) and an optical disk drive 1320 (e.g., which can read or write from disk 1322, for example a CD-ROM disc, a DVD, a BD, etc.). While the internal HDD 1314 is illustrated as located within the computer 1302, the internal HDD 1314 can also be configured for external use in a suitable chassis (not shown). Additionally, while not shown in environment 1300, a solid-state drive (SSD) could be used in addition to, or in place of, an HDD 1314. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can comprise a security module, such as a trusted processing module (TPM). For instance, with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are examples and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

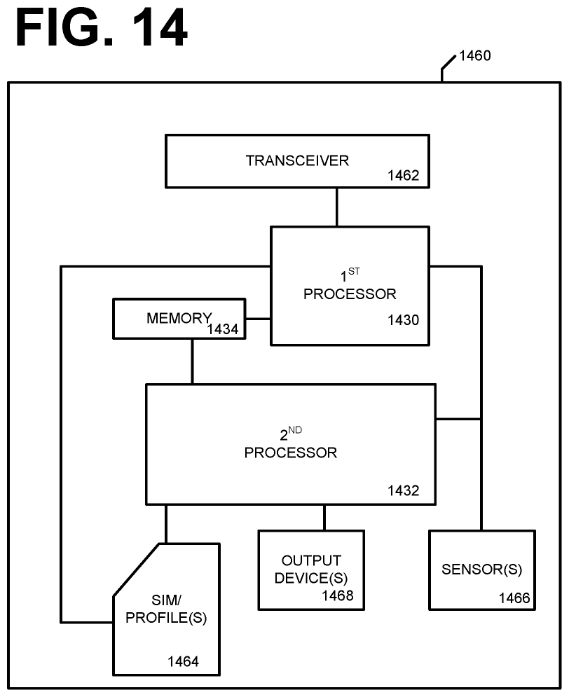

Turning now to FIG. 14, the figure illustrates a block diagram of an example UE 1460. UE 1460 may comprise a smart phone, a wireless tablet, a laptop computer with wireless capability, a wearable device, a machine device that may facilitate vehicle telematics, an intermediate XR processing unit, and the like. UE 1460 may comprise a first processor 1430, a second processor 1432, and a shared memory 1434. UE 1460 may include radio front end circuitry 1462, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 1462 may comprise multiple sets of circuitry or may be tunable to accommodate different frequency ranges, different modulations schemes, or different communication protocols, to facilitate long-range wireless links such as links 125, device-to-device links, such as links 135, and short-range wireless links, such as links 137.

Continuing with description of FIG. 14, UE 1460 may also include a SIM 1464, or a SIM profile, which may comprise information stored in a memory (memory 1434 or a separate memory portion), for facilitating wireless communication with RAN 105 or core network 130 shown in FIG. 1. FIG. 14 shows SIM 1464 as a single component in the shape of a conventional SIM card, but it will be appreciated that SIM 1464 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1464 and another device, which may be a component of RAN 105 or core network 130 shown in FIG. 1). A SIM profile 1464 may also comprise identifying information that is unique to the SIM, or SIM profile, such as, for example, an International Mobile Subscriber Identity (“IMSI”) or information that may make up an IMSI.

SIM 1464 is shown coupled to both first processor portion 1430 and second processor portion 1432. Such an implementation may provide an advantage that first processor portion 1430 may not need to request or receive information or data from SIM 1464 that second processor 1432 may request, thus eliminating the use of the first processor acting as a ‘go-between’ when the second processor uses information from the SIM in performing its functions and in executing applications. First processor 1430, which may be a modem processor or baseband processor, is shown smaller than processor second 1432, which may be a more sophisticated application processor than the first processor, to visually indicate the relative levels of sophistication (i.e., processing capability and performance) and corresponding relative levels of operating power consumption levels between the two processor portions. Keeping the second processor portion 1432 asleep/inactive/in a low power state when UE 1460 does not need the second processor for executing applications and processing data related to an application provides an advantage of reducing power consumption when the UE only needs to use the first processor portion 1430 while in listening mode for monitoring routine configured bearer management and mobility management/maintenance procedures, or for monitoring search spaces that the UE has been configured to monitor while the second processor portion remains inactive/asleep.

UE 1460 may also include sensors 1466, such as, for example, temperature sensors, accelerometers, gyroscopes, barometers, moisture sensors, light sensors, and the like that may provide signals to the first processor 1430 or second processor 1432. Output devices 1468 may comprise, for example, one or more visual displays (e.g., computer monitors, VR appliances, and the like), acoustic transducers, such as speakers or microphones, vibration components, and the like. Output devices 1468 may comprise software that interfaces with output devices, for example, visual displays, speakers, microphones, touch sensation devices, smell or taste devices, and the like, that are external to UE 1460.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QOS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| gNB | General NodeB |
| PUCCH | Physical uplink control channel |
| PUSCH | Physical uplink shared channel |
| SRS | Sounding reference signal |
| NES | Network energy saving |
| QCI | Quality class indication |
| RSRP | Reference signal received power |
| PCI | Primary cell ID |
| BWP | Bandwidth Part |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
facilitating, by a first radio network node comprising at least one processor, receiving, from network computing equipment, an adaptive session transfer configuration comprising at least one session transfer criterion;
determining, by the first radio network node, at least one radio characteristic corresponding to a user equipment;
analyzing, by the first radio network node, the at least one radio characteristic with respect to the at least one session transfer criterion to result in at least one analyzed radio characteristic; and
based on the at least one analyzed radio characteristic corresponding to satisfaction of the at least one session transfer criterion, facilitating, by the first radio network node, transmitting, to the user equipment, context information, corresponding to an existing communication session between the first radio network node and the user equipment, to be usable by the user equipment to facilitate continuance of the existing communication session with a second radio network node.

2. The method of claim 1, wherein the first radio network node is a terrestrial radio network node, and wherein the second radio network node comprises a satellite.

3. The method of claim 2, wherein the context information comprises a link recovery configuration comprising a timing advance indication indicative of a timing advance corresponding to the second radio network node.

4. The method of claim 1, wherein the at least one radio characteristic is a number, determined by the first radio network node, of communication link failures between the user equipment and the first radio network node to result in a determined link failure number, and wherein the satisfaction of the at least one session transfer criterion corresponds to the determined link failure number failing to be less than a threshold specified by the at least one session transfer criterion.

5. The method of claim 1, further comprising:
facilitating, by the first radio network node, receiving, from the user equipment, a radio parameter measurement report comprising an indication of the at least one radio characteristic, wherein the at least one radio characteristic is a signal strength measured value, determined by the user equipment, corresponding to a downlink signal transmitted by the first radio network node, wherein the determining of the at least one radio characteristic corresponding to user equipment comprises retrieving the indication of the at least one radio characteristic from the radio parameter measurement report, and wherein the satisfaction of the at least one session transfer criterion corresponds to the signal strength measured value failing to be greater than a threshold specified by the at least one session transfer criterion.

6. The method of claim 1, wherein the context information comprises a link recovery configuration comprising a context information identifier indicative of context information corresponding to the existing communication session.

7. The method of claim 6, wherein the context information identifier is usable by the user equipment to transmit, to the second radio network node, a session transfer request message that comprises the context information to be usable by the second radio network node to facilitate the existing communication session.

8. The method of claim 7, wherein the link recovery configuration further comprises at least one non-terrestrial resource indication indicative of at least one non-terrestrial resource usable by the user equipment to transmit to the second radio network node a session transfer request message.

9. The method of claim 1, further comprising:
facilitating, by the first radio network node, transmitting, to the second radio network node, a session context retrieval report that comprises session information, corresponding to the existing communication session, to be usable by the second radio network node to facilitate the existing communication session with the user equipment.

10. The method of claim 9, wherein the session information comprises at least one of: at least one capability indication indicative of at least one capability associated with the user equipment, at least one encryption indication indicative of at least one encryption corresponding to the existing communication session, at least one retransmission indication indicative of at least one traffic packet, corresponding to the existing communication session, scheduled for retransmission by the first radio network node to the user equipment, or at least one traffic payload packet, corresponding to the existing communication session, scheduled for transmission by the first radio network node to the user equipment.

11. The method of claim 1, wherein the first radio network node is a terrestrial radio network node, wherein the second radio network node is a terrestrial radio network node, and wherein the context information is to be transmitted by the second radio network node to a third radio network node, comprising a satellite, to be usable by the third radio network node to conduct the existing communication session with the user equipment.

12. The method of claim 11, wherein the second radio network node comprises a satellite gateway communicatively coupled to the third radio network node.

13. The method of claim 11, wherein the second radio network node comprises a radio access network node communicatively coupled with a satellite gateway that is communicatively coupled with the third radio network node.

14. The method of claim 1, wherein the network computing equipment comprises computing equipment of a core network to which the first radio network node is communicatively coupled.

15. A first radio network node, comprising:
a processor configured to process executable instructions that, when executed by the processor, facilitate performance of operations, comprising:
receiving, from a second radio network node, a session information message comprising session information, corresponding to an existing communication session associated with a user equipment, usable by the first radio network node to facilitate the existing communication session with the user equipment;
receiving, from the user equipment, a session transfer request message comprising a session transfer indication indicative to the first radio network node to conduct the existing communication session with the user equipment according to the session information; and
conducting, with the user equipment, the existing communication session according to the session information.

16. The first radio network node of claim 15, wherein the first radio network node comprises a satellite.

17. The first radio network node of claim 16, wherein the second radio network node is a satellite gateway communicatively coupled to a third radio network node that comprises a terrestrial radio access network node, and wherein the session information is received by the second radio network node from the third radio network node.

18. The first radio network node of claim 17, wherein the session information is received by the third radio network node from a fourth radio network node that comprises a terrestrial radio access network node, and wherein the existing communication session is established between the fourth radio network node and the user equipment before the conducting of the existing communication session between the first radio network node and the user equipment as a result of the session transfer indication.

19. A non-transitory machine-readable medium, comprising executable instructions that, when executed by at least one processor of a terrestrial radio access network node, facilitate performance of operations, comprising:
receiving, from network computing equipment, an adaptive session transfer configuration comprising at least one session transfer criterion;
determining at least one radio characteristic corresponding to a user equipment with respect to which the terrestrial radio access network node is conducting an existing communication session;
analyzing the at least one radio characteristic with respect to the at least one session transfer criterion to result in at least one analyzed radio characteristic;
based on the at least one analyzed radio characteristic corresponding to satisfaction of the at least one session transfer criterion, transmitting, to the user equipment, context information, corresponding to an existing communication session, to be usable by the user equipment to facilitate continuance of the existing communication session with a second radio network node; and
directing, to a non-terrestrial radio network node, a transmission of session information, corresponding to the existing communication session, to be usable by the non-terrestrial radio network node to facilitate conducting of the existing communication session with the user equipment.

20. The non-transitory machine-readable medium of claim 19, wherein the session information comprises at least one of: at least one capability indication indicative of at least one capability associated with the user equipment, at least one encryption indication indicative of at least one encryption corresponding to the existing communication session, at least one retransmission indication indicative of at least one traffic packet, corresponding to the existing communication session, scheduled for retransmission by the terrestrial radio access network node to the user equipment, or at least one traffic payload packet scheduled for transmission by the terrestrial radio access network node to the user equipment.
